(19) United States
(12) Patent Application Publication
(10) Pub. No.: US 2008/0142051 A1
(43) Pub. Date: Jun. 19, 2008

(54) RECOVERY CUP CLEANING METHOD AND SUBSTRATE TREATMENT APPARATUS

(76) Inventor: Akio Hashizume, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/957,024

(22) Filed: Dec. 14, 2007

(30) Foreign Application Priority Data
Dec. 19, 2006 (JP) 2006-341460

(51) Int. Cl. B08B 9/08; B08B 3/08; B08B 13/00

(52) U.S. Cl. 134/23; 134/22.1; 134/56 R

(57) ABSTRACT

An inventive recovery cup cleaning method is a method for cleaning a recovery cup having an interior wall partitioning a recovery space into which a chemical agent used for treating a substrate is introduced, the recovery cup being configured such that the chemical agent introduced into the recovery space is further introduced into a predetermined chemical agent recovery passage so as to be recovered. The method comprises the steps of: cleaning the interior wall of the recovery space with a cleaning liquid; cleaning the interior wall of the recovery space with a chemical cleaning agent after the step of cleaning with the cleaning liquid, the chemical cleaning agent being of the same type as the chemical agent to be recovered through the recovery space; and draining the cleaning liquid introduced into the recovery space in the step of cleaning with the cleaning liquid and the chemical cleaning agent introduced into the recovery space in the step of cleaning with the chemical cleaning agent through a drain passage which is different from the chemical agent recovery passage.

### BACKGROUND OF THE INVENTION

1. Field of the Invention

The present invention relates to a recovery cup cleaning method for cleaning a recovery cup into which a chemical agent used for treatment of a substrate is introduced, and a substrate treatment apparatus employing the recovery cup cleaning method. Examples of the substrate to be treated include semiconductor wafers, glass substrates for liquid crystal display devices, glass substrates for plasma display devices, substrates for FED (Field Emission Display) devices, substrates for optical disks, substrates for magnetic disks, substrates for magneto-optical disks, and substrates for photo masks.

2. Description of Related Art

In production processes for semiconductor devices and liquid crystal display devices, substrate treatment apparatuses of a single substrate treatment type are used for treating a surface of a substrate (e.g., a semiconductor wafer or a glass substrate for a liquid crystal display panel) with a chemical agent. For reduction of the consumption of the chemical agent, some of the substrate treatment apparatuses of this type are adapted to recover the chemical agent used for the treatment of the substrate and reuse the recovered chemical agent for the subsequent treatment.

Such a substrate treatment apparatus adapted to reuse the chemical agent includes, for example, a spin chuck which horizontally holds and rotates the substrate, first and second nozzles which respectively supply chemical agents to a surface of the substrate held by the spin chuck, and a recovery cup which receives a treatment liquid scattered from the substrate to recover the treatment liquid (e.g., US2004/0050491A1).

The recovery cup has, for example, a plurality of annular openings vertically arranged as surrounding the spin chuck. The recovery cup is vertically movable relative to the spin chuck. The openings are selectively brought into opposed relation to a peripheral surface of the substrate held by the spin chuck by the vertical movement of the recovery cup.

The substrate treatment apparatus having the aforesaid construction is capable of treating the surface of the substrate with a chemical agent (first chemical agent) supplied from the first nozzle and with a chemical agent (second chemical agent) supplied from the second nozzle, and separately recovering the chemical agents used for the treatment.

More specifically, the substrate surface is treated with the first chemical agent by supplying the first chemical agent to the substrate surface from the first nozzle while rotating the substrate by the spin chuck. The first chemical agent supplied to the substrate surface is scattered radially outward from a peripheral edge of the substrate by a centrifugal force generated by the rotation of the substrate. At this time, a first opening of the recovery cup, for example, is kept in opposed relation to the peripheral surface of the substrate, whereby the first chemical agent scattered from the peripheral edge of the substrate flies into the first opening. The first chemical agent flying into the first opening is introduced into a first chemical agent recovery passage through a first chemical agent recovery space communicating with the first opening. Then, the first chemical agent is recovered in a first chemical agent recovery tank through the first chemical agent recovery passage, and supplied again to the substrate from the first nozzle.

Further, the substrate surface is treated with the second chemical agent by supplying the second chemical agent to the substrate surface from the second nozzle while rotating the substrate by the spin chuck. At this time, a second opening of the recovery cup is kept in opposed relation to the peripheral surface of the substrate, whereby the second chemical agent scattered from the peripheral edge of the substrate by the centrifugal force flies into the second opening. The second chemical agent flying into the second opening is introduced into a second chemical agent recovery passage through a second chemical agent recovery space communicating with the second opening. Then, the second chemical agent is recovered in a second chemical agent recovery tank through the second chemical agent recovery passage, and supplied again to the substrate from the second nozzle.

However, the chemical agents recovered from the chemical agent recovery passages are each liable to contain foreign matter. The foreign matter is liable to be present in the form of particles to contaminate the substrate.

Where a polymer removing process is performed after an ashing process for removing an unnecessary resist film from the substrate surface, for example, a chemical agent is supplied to the surface of the substrate subjected to the ashing process to remove a great amount of a polymer (residual resist) from the substrate surface. The great amount of the polymer is introduced together with the chemical agent into the chemical agent recovery passage through the recovery space of the recovery cup. However, the polymer is liable to adhere onto an interior wall of the recovery space when passing through the recovery space. The polymer is crystallized on the interior wall with time. In this case, the chemical agent flowing through the recovery space is contaminated with the crystallized polymer as foreign matter. Further, if the chemical agent used for the treatment of the substrate is left on the interior wall of the recovery space of the recovery cup after the treatment, the chemical agent is crystallized with time. In this case, the chemical agent flowing through the recovery space is contaminated with the crystallized chemical agent as foreign matter.

Therefore, it is desirable to remove substances adhering on the interior wall of the recovery cup by cleaning the interior wall with a cleaning liquid.

However, when the interior wall of the recovery cup is cleaned with the cleaning liquid, the cleaning liquid is liable to enter the chemical agent recovery passage to contaminate the chemical agent stored in the recovery tank. If the cleaning liquid is mixed with the chemical agent, the chemical agent is diluted to be deteriorated. This reduces a treatment rate in the substrate treatment process.

### SUMMARY OF THE INVENTION

It is an object of the present invention to provide a recovery cup cleaning method which suppresses ingress of a cleaning liquid in a chemical agent passage when an interior wall of a recovery space is cleaned with the cleaning liquid.

It is another object of the present invention to provide a substrate treatment apparatus which is capable of properly treating a substrate with a chemical agent while suppressing generation of particles.

A recovery cup cleaning method according to the present invention is a method for cleaning a recovery cup having an interior wall partitioning a recovery space into which a chemical agent used for treating a substrate is introduced, the recovery cup being configured such that the chemical agent introduced into the recovery space is further introduced into a predetermined chemical agent recovery passage so as to be recovered. The method comprises the steps of: cleaning the interior wall of the recovery space with a cleaning liquid; cleaning the interior wall of the recovery space with a chemical cleaning agent after the step of cleaning with the cleaning liquid, the chemical cleaning agent being of the same type as the chemical agent to be recovered through the recovery space; and draining the cleaning liquid introduced into the recovery space in the step of cleaning with the cleaning liquid and the chemical cleaning agent introduced into the recovery space in the step of cleaning with the chemical cleaning agent through a drain passage which is different from the chemical agent recovery passage.

In this method, the interior wall of the recovery space is cleaned with the cleaning liquid and with the chemical cleaning agent, and the cleaning liquid and the chemical cleaning agent used for the cleaning are drained from the recovery space through the drain passage. This suppresses or prevents the ingress of the cleaning liquid used for the cleaning of the interior wall of the recovery space in the chemical agent recovery passage. Therefore, even if the interior wall of the recovery space is cleaned with the cleaning liquid, the chemical agent to be supplied is unlikely to be contaminated with the cleaning liquid. This makes it possible to properly treat the substrate with the chemical agent.

After the interior wall of the recovery space is cleaned with the cleaning liquid, the interior wall of the recovery space is cleaned with the chemical cleaning agent which is the same type as the chemical agent. Therefore, the cleaning liquid adhering onto the interior wall of the recovery space is rinsed away with the chemical cleaning agent after the step of cleaning with the cleaning liquid. This more reliably suppresses or prevents the contamination of the chemical agent to be supplied with the cleaning liquid.

Where the recovery space surrounds a substrate rotation unit which holds and rotates the substrate, the method preferably further comprises the step of operating the substrate rotation unit in the step of cleaning with the cleaning liquid and in the step of cleaning with the chemical cleaning agent, wherein the step of cleaning with the cleaning liquid includes the step of supplying the cleaning liquid toward the substrate rotation unit, wherein the step of cleaning with the chemical cleaning agent includes the step of supplying the chemical cleaning agent toward the substrate rotation unit.

In this case, the cleaning liquid or the chemical cleaning agent is supplied to the operated substrate rotation unit. Therefore, the cleaning liquid or the chemical cleaning agent impinges on the substrate rotation unit, and is scattered around the substrate rotation unit to be introduced into the recovery space. The cleaning liquid or the chemical cleaning agent introduced into the recovery space flows down on the interior wall, whereby the interior wall of the recovery space is cleaned. Thus, the cleaning liquid or the chemical cleaning agent can be introduced into the recovery space of the recovery cup by a simple method.

The substrate rotation unit operating step may be the step of rotating a dummy substrate held by the substrate rotation unit, wherein the cleaning liquid supplying step includes the step of supplying the cleaning liquid to the dummy substrate being rotated, wherein the chemical cleaning agent supplying step includes the step of supplying the chemical cleaning agent to the dummy substrate being rotated. In this case, the cleaning liquid or the chemical cleaning agent supplied to the dummy substrate flows toward a peripheral edge of the dummy substrate by a centrifugal force generated by the rotation of the dummy substrate, and is scattered from the peripheral edge. The dummy substrate has, for example, the same shape and the same size as the substrate to be treated, so that the cleaning liquid and the chemical cleaning agent scattered from the peripheral edge of the dummy substrate are introduced into the recovery space in the same manner as the chemical agent scattered from a peripheral edge of the substrate during the treatment of the substrate. Thus, the interior wall of the recovery space can be efficiently cleaned with the cleaning liquid and with the chemical cleaning agent.

The substrate rotation unit operating step preferably includes the step of changing an operation speed of the substrate rotation unit. In this case, when the operation speed of the substrate rotation unit is changed, a liquid scattering direction in which the cleaning liquid or the chemical cleaning agent is scattered from the substrate rotation unit is changed and, hence, a liquid reaching position which the cleaning liquid or the chemical cleaning agent reaches in the recovery cup is changed. Therefore, the cleaning liquid or the chemical cleaning agent is distributed over a wider range in the recovery space by changing the operation speed of the substrate rotation unit within a predetermined range. This makes it possible to more advantageously clean the interior wall of the recovery space.

The method preferably further comprises the step of moving the substrate rotation unit and the recovery cup relative to each other parallel to a rotation axis of the substrate rotated by the substrate rotation unit in at least one of the step of cleaning with the cleaning liquid and the step of cleaning with the chemical cleaning agent. During the cleaning of the recovery cup, the liquid reaching position of the cleaning liquid or the chemical cleaning agent in the recovery cup is changed by moving the substrate rotation unit and the recovery cup relative to each other parallel to the rotation axis of the substrate. Therefore, the cleaning liquid or the chemical cleaning agent is distributed over a wider range in the recovery space by changing the operation speed of the substrate rotation unit within a predetermined range. This makes it possible to more advantageously clean the interior wall of the recovery space.

A substrate treatment apparatus according to the present invention comprises a chemical agent supply unit which supplies a chemical agent to a substrate, a recovery cup having an interior wall partitioning a recovery space into which the chemical agent used for treating the substrate is introduced, a chemical agent recovery passage through which the chemical agent introduced into the recovery space is recovered, a drain passage through which a liquid introduced into the recovery space is drained, a switching unit configured such that the liquid introduced into the recovery space is further introduced selectively into the chemical agent recovery passage and into the drain passage, a cleaning liquid supply unit which supplies a cleaning liquid for cleaning the interior wall of the recovery space, a chemical cleaning agent supply unit which supplies a chemical cleaning agent to the interior wall of the recovery space after the cleaning liquid is supplied to the interior wall of the recovery space by the cleaning liquid supply unit, the chemical cleaning agent being of the same type as the chemical agent to be recovered through the recovery space, and a control unit which controls the switching unit so that the chemical agent introduced into the recovery space is further introduced into the chemical agent recovery passage when the chemical agent is supplied to the substrate by the chemical agent supply unit, and the liquid introduced into the recovery space is further introduced into the drain passage when the cleaning liquid is supplied to the interior wall of the recovery space by the cleaning liquid supply unit and when the chemical cleaning agent is supplied to the interior wall of the recovery space by the chemical cleaning agent supply unit.

With this arrangement, the interior wall of the recovery space is cleaned with the cleaning liquid and with the chemical cleaning agent, and the cleaning liquid and the chemical cleaning agent used for the cleaning is introduced into the drain passage from the recovery space to be drained. This suppresses or prevents the ingress of the cleaning liquid used for the cleaning of the interior wall of the recovery space in the chemical agent recovery passage. Therefore, even if the interior wall of the recovery space is cleaned with the cleaning liquid, the chemical agent to be supplied is unlikely to be contaminated with the cleaning liquid. This makes it possible to properly treat the substrate with the chemical agent.

The apparatus preferably further includes a substrate rotation unit which holds and rotates the substrate, wherein the chemical agent supply unit includes a chemical agent nozzle which supplies the chemical agent toward the substrate rotation unit, wherein the cleaning liquid supply unit includes a cleaning liquid nozzle which supplies the cleaning liquid toward the substrate rotation unit, wherein the chemical cleaning agent supply unit includes a chemical cleaning agent nozzle which supplies the chemical cleaning agent toward the substrate rotation unit.

In this case, the cleaning liquid is supplied from the cleaning liquid nozzle toward the substrate rotation unit being rotated. Further, the chemical cleaning agent is supplied from the chemical cleaning agent nozzle. The cleaning liquid or the chemical cleaning agent supplied toward the substrate rotation unit is scattered around the substrate rotation unit by a centrifugal force generated by the rotation of the substrate rotation unit, and introduced into the recovery space. The cleaning liquid or the chemical cleaning agent flows down on the interior wall of the recovery space, whereby the interior wall of the recovery space is cleaned.

The chemical agent supply unit may double as the chemical cleaning agent supply unit. Thus, the construction of the apparatus is simplified.

The substrate rotation unit and the recovery cup may be accommodated in a treatment chamber, and a dummy substrate holder for holding a dummy substrate to be held by the substrate rotation unit may be provided outside the treatment chamber. In this case, the substrate rotation unit accommodated in the treatment chamber can easily hold the dummy substrate because the dummy substrate holder is provided outside the treatment chamber.

The foregoing and other objects, features and effects of the present invention will become more apparent from the following detailed description of preferred embodiments with reference to the attached drawings.

### BRIEF DESCRIPTION OF THE DRAWINGS

FIG. 1 is a schematic plan view showing the layout of a substrate treatment apparatus according to one embodiment of the present invention.

FIG. 2 is a sectional view schematically showing the internal construction of a treatment unit by way of example.

FIG. 3 is a block diagram for explaining the configuration of a control system of the substrate treatment apparatus of FIG. 1.

FIG. 4 is a flow chart for explaining an exemplary treatment to be performed by the treatment unit of FIG. 2.

FIGS. 5(a) to 5(e) are sectional views schematically showing the operations of a spin chuck and a recovery cup during the treatment of a substrate (wafer).

FIG. 6 is a flow chart for explaining a process sequence of a recovery cup cleaning process.

FIG. 7 is a sectional view schematically showing the construction of a treatment unit of a substrate treatment apparatus according to another embodiment of the present invention by way of example.

FIGS. 8(a) to 8(c) are sectional views schematically showing the operations of a spin chuck and a recovery cup during the treatment of a substrate (wafer) to be performed by the substrate treatment apparatus according to the second embodiment.

### DETAILED DESCRIPTION OF PREFERRED EMBODIMENTS

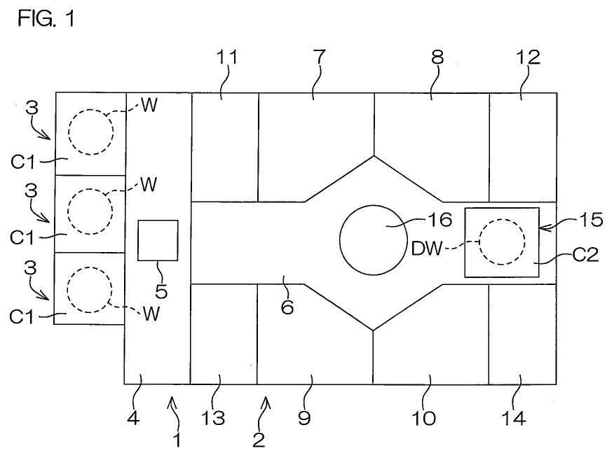

FIG. 1 is a schematic plan view showing the layout of a substrate treatment apparatus according to one embodiment (first embodiment) of the present invention. The substrate treatment apparatus is of a single substrate treatment type which is adapted to treat semiconductor wafers W one by one (such a semiconductor wafer is an example of a substrate and hereinafter referred to simply as “wafer”). The substrate treatment apparatus includes an indexer section 1, a substrate treatment section 2 connected to one side of the indexer section 1, and a plurality of cassette holders 3 (three cassette holders 3 in this embodiment) aligned on the other side of the indexer section 1 (opposite from the substrate treatment section 2). Cassettes C1 in which a plurality of wafers Ware stored in a stacked state are respectively disposed on the cassette holders 3. Examples of the cassettes C1 include a FOUP (Front Opening Unified Pod) which is configured to store a plurality of wafers W in a sealed state, an SMIF (Standard Mechanical Inter Face) pod and an OC (Open Cassette).

A linear transport path 4 is provided in the indexer section 1 as extending alongside the alignment of the cassette holders 3.

An indexer robot 5 is provided in the linear transport path 4. The indexer robot 5 is reciprocally movable along the linear transport path 4 to be brought into opposed relation to any of the cassettes C1 respectively disposed on the cassette holders 3. The indexer robot 5 includes hands (not shown) for holding a wafer W. With the indexer robot 5 being opposed to the cassette C1, the hands of the indexer robot 5 access the cassette C1 to take an untreated wafer W out of the cassette C1 and take a treated wafer W into the cassette C1. With the indexer robot 5 being located in a middle portion of the linear transport path 4, the hands of the indexer robot 5 access the substrate treatment section 2 to transfer the untreated wafer W to a transport robot 16 to be described later and receive the treated wafer W from the transport robot 16.

A transport chamber 6 is provided in the substrate treatment section 2 as extending from the middle portion of the linear transport path 4 of the indexer section 1 perpendicularly to the linear transport path 4. The substrate treatment section 2 includes four treatment units 7, 8, 9, 10, and fluid boxes 11, 12, 13, 14, the number of which is the same as the number of the treatment units 7 to 10. More specifically, the treatment units 7, 8 are arranged along the transport chamber 6 on one of opposite sides of the transport chamber 6 with respect to a direction perpendicular to the longitudinal axis of the transport chamber 6. The fluid box 11 is disposed on a side of the treatment unit 7 opposite from the treatment unit 8, and the fluid box 12 is disposed on a side of the treatment unit 8 opposite from the treatment unit 7. The treatment units 9 and 10 are disposed in opposed relation to the treatment units 7 and 8, respectively, with the intervention of the transport chamber 6. The fluid box 13 is disposed on a side of the treatment unit 9 opposite from the treatment unit 10, and the fluid box 14 is disposed on a side of the treatment unit 10 opposite from the treatment unit 9.

The transport robot 16 is disposed in a middle portion of the transport chamber 6. The transport robot 16 includes hands (not shown) which hold a wafer W. The transport robot 16 causes its hands to access the treatment units 7 to 10 to load and unload the wafer W into and out of the treatment units 7 to 10. The wafer W is transferred between the transport robot 16 and the indexer robot 5.

A dummy wafer holding base 15 for holding a dummy wafer DW to be used for a recovery cup cleaning process to be described later is disposed on a side of the transport robot 16 opposite from the indexer section 1. A cassette C2 which accommodates a plurality of dummy wafers DW (e.g., four dummy wafers) in a stacked state is placed on the dummy wafer holding base 15.

The transport robot 16 is capable of taking a dummy wafer DW out of the cassette C2 on the dummy wafer holding base 15 and taking a used dummy wafer DW into the cassette C2 on the dummy wafer holding base 15. The transport robot 16 causes its hands to access any of the treatment units 7 to 10 to load and unload the dummy wafer DW into and out of the treatment unit 7 to 10. The treatment units 7 to 10 may be adapted to perform the same treatment process or to perform different treatment processes.

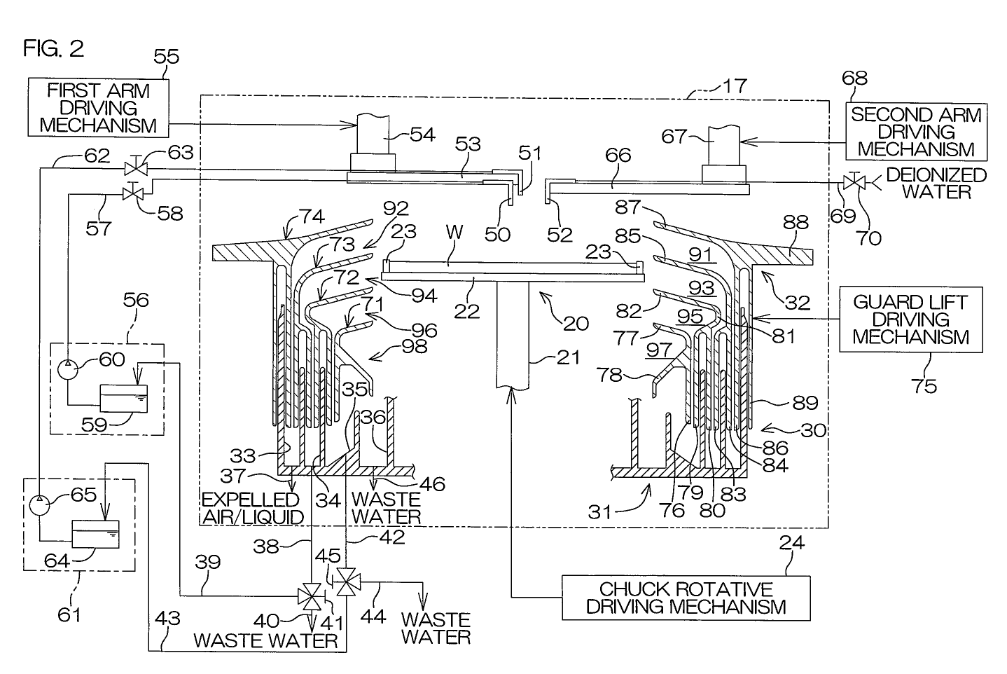

FIG. 2 is a sectional view schematically showing the internal construction of the treatment unit 7 by way of example. The treatment unit 7 is adapted to selectively supply a first chemical agent, a second chemical agent and pure water (deionized water) to treat a wafer W with the first chemical agent and with the second chemical agent. Disposed in a treatment chamber 17 of the treatment unit 7 are a spin chuck 20 which horizontally holds and rotates the wafer W, a recovery cup 30 which accommodates the spin chuck 20, and a first chemical agent nozzle 50, a second chemical agent nozzle 51 and a pure water nozzle 52 which respectively supply the first chemical agent, the second chemical agent and the deionized water to a surface of the wafer W held by the spin chuck 20.

The spin chuck 20 includes a spin shaft 21 extending generally vertically, a spin base 22 generally horizontally attached to an upper end of the spin shaft 21, and a plurality of holding members 23 provided upright on an upper surface of the spin base 22. The upper surface of the spin base 22 is flat. The plurality of holding members 23 are equidistantly arranged circumferentially of the spin base 22 about a rotation axis of the spin shaft 21. The holding members 23 hold a peripheral surface of the wafer W at different positions to generally horizontally hold the wafer W.

A chuck rotative driving mechanism 24 including a driving source such as a motor is connected to the spin shaft 21. With the wafer W being held by the plurality of holding members 23, a rotation force is inputted to the spin shaft 21 from the chuck rotative driving mechanism 24 to rotate the spin shaft 21 about its center axis, whereby the wafer W is rotated together with the spin base 22 about the center axis of the spin shaft 21.

The first chemical agent nozzle 50 and the second chemical agent nozzle 51 are attached to a distal end of a first arm 53 provided above the spin chuck 20. The first arm 53 is supported by an arm support shaft 54 extending generally vertically on a lateral side of the spin chuck 20, and extends generally horizontally from a lower end of the arm support shaft 54. A first arm driving mechanism 55 is connected to the arm support shaft 54. The arm support shaft 54 is pivoted within a predetermined angular range by a driving force generated by the first arm driving mechanism 55, whereby the first arm 53 is horizontally pivotal within the predetermined angular range.

The first chemical agent is supplied from a first chemical agent supply source 56 to the first chemical agent nozzle 50 through a first chemical agent supply passage 57. A first chemical agent valve 58 for selectively permitting and preventing the supply of the first chemical agent is provided in the first chemical agent supply passage 57. The first chemical agent supply source 56 includes a first chemical gent tank 59 which stores the first chemical agent, and a chemical agent pump 60 which pumps up the first chemical agent from the first chemical agent tank 59 to supply the first chemical agent to the first chemical agent supply passage 57.

The second chemical agent is supplied from a second chemical agent supply source 61 to the second chemical agent nozzle 51 through a second chemical agent supply passage 62. A second chemical agent valve 63 for selectively permitting and preventing the supply of the second chemical agent is provided in the second chemical agent supply passage 62. The second chemical agent supply source 61 includes a second chemical gent tank 64 which stores the second chemical agent, and a chemical agent pump 65 which pumps up the second chemical agent from the second chemical agent tank 64 to supply the second chemical agent to the second chemical agent supply passage 62.

Chemical agents suitable for the treatment of the surface of the wafer W are used as the first chemical agent and the second chemical agent. Where a resist lift-off process is performed for removing an unnecessary resist film from the surface of the wafer W, for example, a resist removing liquid such as SPM (Sulfuric acid/hydrogen Peroxide Mixture) is employed. Where a polymer removing process is performed for removing a polymer (residual resist) from the surface of the wafer W, a polymer removing liquid such as APM (Ammonia/hydrogen Peroxide Mixture) is employed. Where an etching process is performed for etching off an oxide film, a metal thin film or the like from the surface of the wafer W, an etching liquid including at least one of hydrofluoric acid, sulfuric acid, nitric acid, hydrochloric acid, phosphoric acid, acetic acid, ammonia, aqueous hydrogen peroxide, citric acid, oxalic acid, TMAH and aqua regia is employed.

The pure water nozzle 52 is attached to a distal end of a second arm 66 provided above the spin chuck 20. The second arm 66 is supported by an arm support shaft 67 extending generally vertically on a lateral side of the spin chuck 20, and extends generally horizontally from a lower end of the arm support shaft 67. A second arm driving mechanism 68 is connected to the arm support shaft 67. The arm support shaft 67 is pivoted within a predetermined angular range by a driving force generated by the second arm driving mechanism 68, whereby the second arm 66 is horizontally pivotal within the predetermined angular range.

Deionized water is supplied from a pure water supply source to the pure water nozzle 52 through a pure water supply passage 69. A pure water valve 70 for selectively permitting and preventing the supply of the deionized water is provided in the pure water supply passage 69.

The recovery cup 30 is configured to recover the first chemical agent and the second chemical agent used for the treatment of the wafer W. The recovery cup 30 includes a bottomed cylindrical cup 31, and a splash guard 32 provided above the cup 31 and vertically movable relative to the cup 31.

The cup 31 has an annular drain channel 36 defined about the rotation axis of the wafer W (the center axis of the spin shaft 21) in a bottom portion thereof for draining a treatment liquid (deionized water containing the second chemical agent) used for the treatment of the wafer W. The cup 31 further has an annular first recovery channel 34 and an annular second recovery channel 35 provided in the bottom portion thereof as surrounding the drain channel 36 for recovering the first chemical agent and the second chemical agent, respectively, used for the treatment of the wafer W. More specifically, the second recovery channel 35 is provided outward of the drain channel 36, and the first recovery channel 34 is provided outward of the second recovery channel 35. Further, the cup 31 has an air/liquid expelling channel 33 surrounding the first recovery channel 34 for draining a treatment liquid (deionized water containing the first chemical agent) used for the treatment of the wafer W and exhausting ambient air around the wafer W.

An air/liquid expelling passage 37 through which the ambient air and the treatment liquid are introduced into a waste water treatment facility and an exhaust facility not shown is connected to the air/liquid expelling channel 33.

A first recovery/drain passage 38 is connected to the first drain channel 34. A distal end of the first recovery/drain passage 38 is branched into a first branch recovery passage 39 and a first branch drain passage 40. A first selector valve 41 for introducing a liquid flowing through the first recovery/drain passage 38 selectively into the first branch recovery passage 39 and into the first branch drain passage 40 is provided in the first recovery/drain passage 38. The first selector valve 41 is, for example, a three-way valve. A distal portion of the first branch recovery passage 39 extends to the first chemical agent tank 59. The first chemical agent used for the treatment of the wafer W is recovered in the first chemical agent tank 59 through the first branch recovery passage 39 to be thereby reusable. The first branch drain passage 40 extends to the waste water treatment facility not shown.

A second recovery/drain passage 42 is connected to the second recovery channel 35. A distal end of the second recovery/drain passage 42 is branched into a second branch recovery passage 43 and a second branch drain passage 44. A second selector valve 45 for introducing a liquid flowing through the second recovery/drain passage 42 selectively into the second branch recovery passage 43 and into the second branch drain passage 44 is provided in the second recovery/drain passage 42. The second selector valve 45 is, for example, a three-way valve. A distal portion of the second branch recovery passage 43 extends to the second chemical agent tank 64. The second chemical agent used for the treatment of the wafer W is recovered in the second chemical agent tank 64 through the second branch recovery passage 43 to be thereby reusable. The second branch drain passage 44 extends to the waste water treatment facility not shown.

A drain passage 46 for introducing the treatment liquid used for the treatment of the wafer W into the waste water treatment facility not shown is connected to the drain channel 36.

The splash guard 32 includes four shade members 71, 72, 73, 74 having different sizes and disposed in vertically overlapping relation. A guard lift driving mechanism 75 such as including a servo motor is connected to the splash guard 32. The splash guard 32 is moved up and down (vertically) relative to the cup 31 by controlling the guard lift driving mechanism 75.

The shade members 71 to 74 each have a shape generally rotationally symmetric about the rotation axis of the wafer W.

The shade member 71 includes a cylindrical portion 76 having a center axis defined by the rotation axis of the wafer W, a tilt portion 77 extending obliquely upward from an upper edge of the cylindrical portion 76 toward the center axis (toward the rotation axis of the wafer W), and a drain guide portion 78 extending obliquely downward from the upper edge of the cylindrical portion 76 toward the center axis. A lower edge of the cylindrical portion 76 is located above the second recovery channel 35. A lower edge of the drain guide portion 78 is located above the drain channel 36.

The shade member 72 includes cylindrical portions 79, 80 provided coaxially around the cylindrical portion 76 of the shade member 71 and each having a center axis defined by the rotation axis of the wafer W, a connection portion 81 connecting upper edges of the cylindrical portions 79, 80 and having a generally U-shaped cross section opening toward the rotation axis of the wafer W, and a tilt portion 82 extending obliquely upward from an upper edge of the connection portion 81 toward the center axis. A lower edge of the inner cylindrical portion 79 (closer to the center axis) is located above the second recovery channel 35. A lower edge of the outer cylindrical portion 80 is located above the first recovery channel 34.

The shade member 73 includes cylindrical portions 83, 84 provided coaxially around the cylindrical portion 80 of the shade member 72 and each having a center axis defined by the rotation axis of the wafer W, and a tilt portion 85 extending obliquely upward from an upper edge of the outer cylindrical portion 84 toward the center axis. A lower edge of the inner cylindrical portion 83 is located above the first recovery channel 34. A lower edge of the outer cylindrical portion 84 is located above the air/liquid expelling channel 33.

The shade member 74 includes cylindrical portions 86, 89 provided around the cylindrical portion 84 of the shade member 73 and having a center axis defined by the rotation axis of the wafer W, and a tilt portion 87 extending obliquely upward from an upper edge of the inner cylindrical portion 86 toward the center axis. A lower edge of the inner cylindrical portion 86 is located above the air/liquid expelling channel 33. The outer cylindrical portion 89 covers a part of an outer peripheral surface of the cup 31. A flange 88 projects outward from a lower edge of the tilt portion 87.

Upper edges of the shade members 71 to 74 are located on a cylindrical plane having a center axis defined by the rotation axis of the wafer W so as to be vertically spaced alongside the rotation axis of the wafer W.

An annular first opening 92 through which the treatment liquid scattered from the wafer W is received in the air/liquid expelling channel 33 is defined between the upper edge of the shade member 74 and the upper edge of the shade member 73. A first space 91 into which the treatment liquid and the like used for the treatment of the wafer W is introduced is defined by an inner surface of the shade member 74, an outer surface of the shade member 73 and the air/liquid expelling channel 33.

An annular second opening 94 through which the first chemical agent scattered from the wafer W is received in the first recovery channel 34 is defined between the upper edge of the shade member 73 and the upper edge of the shade member 72. A second space 93 into which the first chemical agent used for the treatment of the wafer W is introduced is defined by an inner surface of the shade member 73, an outer surface of the shade member 72 and the first recovery channel 34.

An annular third opening 96 through which the second chemical agent scattered from the wafer W is received in the second recovery channel 35 is defined between the upper edge of the shade member 72 and the upper edge of the shade member 71. A third space 95 into which the second chemical agent used for the treatment of the wafer W is introduced is defined by an inner surface of the shade member 72, an outer surface of the shade member 71 and the second recovery channel 35.

A fourth opening 98 for receiving the treatment liquid scattered from the wafer W is defined between an upper edge of the tilt portion 77 and the lower edge of the drain guide portion 78. A fourth space 97 into which the treatment liquid used for the treatment of the wafer W is defined by an inner surface of the shade member 71 and the drain channel 36.

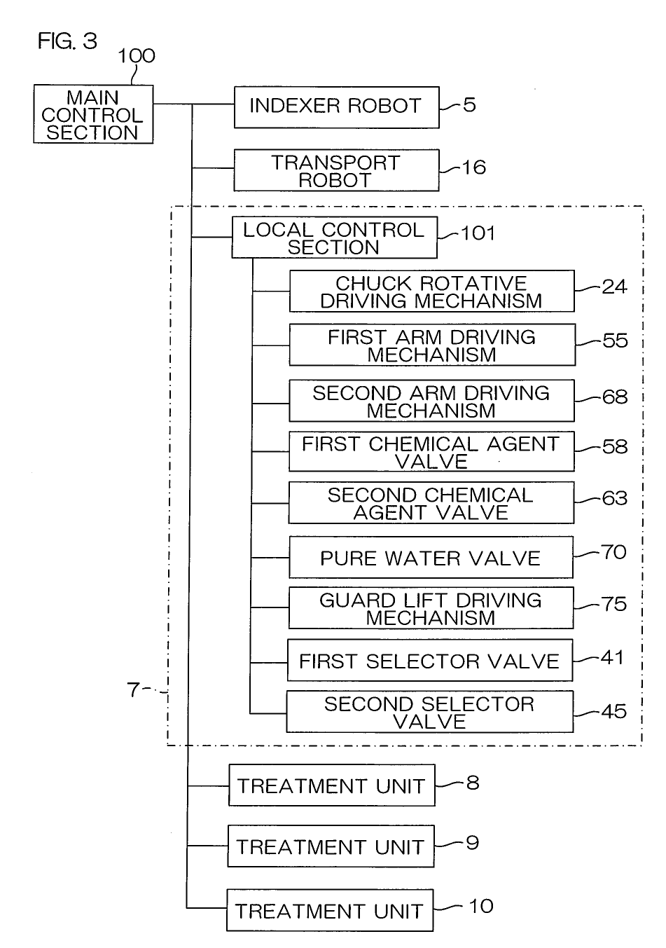

FIG. 3 is a block diagram for explaining the configuration of a control system of the substrate treatment apparatus. In the substrate treatment apparatus, a main control section 100 is connected to the indexer robot 5, the transport robot 16 and the treatment units 7 to 10. The main control section 100 controls a wafer transport operation to be performed for transporting the wafer W by the indexer robot 5 and the transport robot 16. The main control section 100 also controls a dummy wafer transport operation to be performed for transporting the dummy wafer DW by the transport robot 16. Further, the main control section 100 transmits and receives data related to treatment conditions, an operation status and the like to and from the treatment units 7 to 10.

A local control section 101 is provided in the treatment unit 7. The local control section 101 is connected to the chuck rotative driving mechanism 24, the first arm driving mechanism 55, the second arm driving mechanism 68, the first chemical agent valve 58, the second chemical agent valve 63, the pure water valve 70, the guard lift driving mechanism 75, the first selector valve 41, the second selector valve 45 and the like as control objects.

The local control section 101 controls the operations of the chuck rotative driving mechanism 24, the first arm driving mechanism 55, the second arm driving mechanism 68 and the guard lift driving mechanism 75. The local control section 101 also controls the opening and closing of the first chemical agent valve 58, the second chemical agent valve 63 and the pure water valve 70, and the switching of the first selector valve 41 and the second selector valve 45.

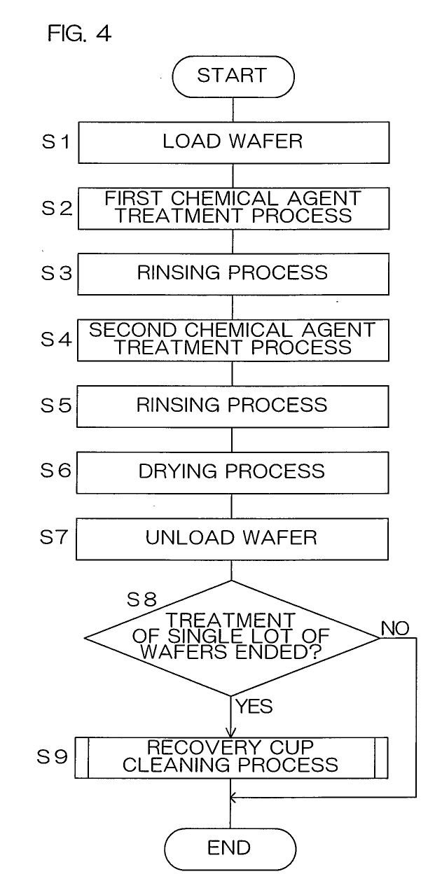

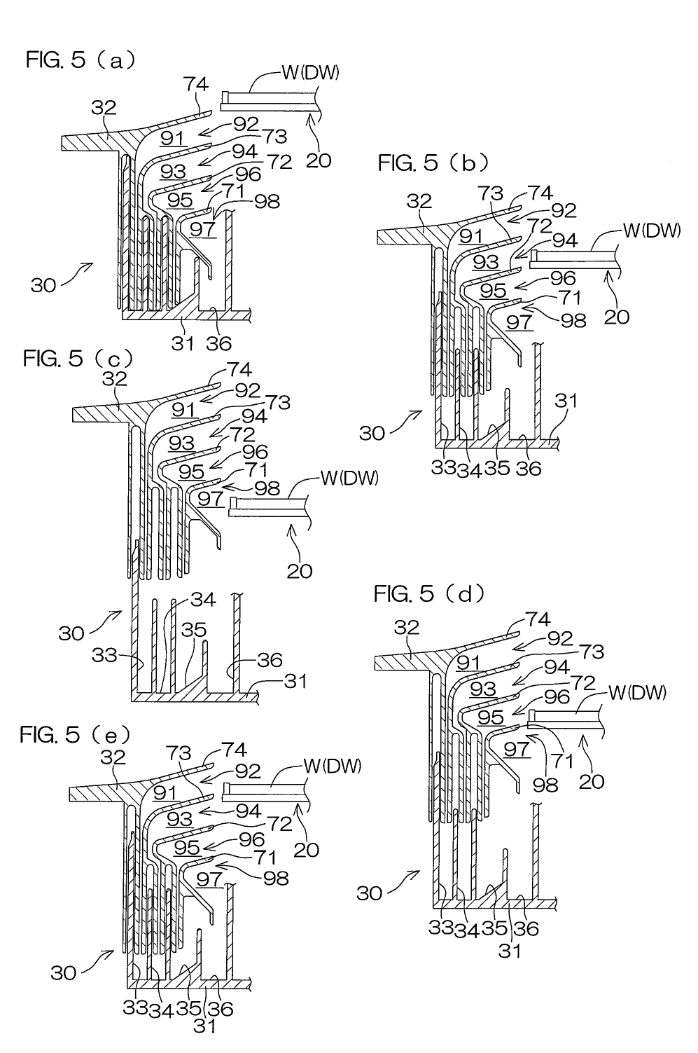

FIG. 4 is a flow chart for explaining an exemplary treatment process to be performed on the wafer W by the treatment unit 7. FIGS. 5(a) to 5(e) are schematic partial sectional views showing positional relationships between the spin chuck 20 and the recovery cup 30 during the wafer treatment process. The wafer treatment process to be performed by the treatment unit 7 will hereinafter be described with reference to FIGS. 2, 3, 4 and 5(a) to 5(e).

Before a wafer W to be treated is loaded, the splash guard 32 is located at the lowermost retracted position (see FIG. 5(a)) so as not to hinder the loading of the wafer W. With the splash guard 32 being located at the retracted position, the upper edge of the shade member 74 is located at a lower level than a wafer holding position at which the wafer W is held by the spin chuck 20.

An untreated wafer W is loaded into the treatment unit 7 for the treatment thereof by the transport robot 16, and held by the spin chuck 20 with its front face (device formation surface) up (Step S1). With the wafer W being held by the spin chuck 20, the chuck rotative driving mechanism 24 is controlled to cause the spin chuck 20 to start rotating the wafer W (rotating the spin base 22) and then increase the rotation speed of the wafer W up to 1500 rpm, for example. The guard lift driving mechanism 75 is controlled to move the splash guard 32 up to a second opening opposed position (see FIG. 5(b)) at which the second opening 94 is opposed to a peripheral surface of the wafer W. Further, the first arm driving mechanism 55 is controlled to pivot the first arm 53 to move the first chemical agent nozzle 50 and the second chemical agent nozzle 51 from a retracted position on a lateral side of the spin chuck 20 to above the wafer W.

When the rotation speed of the wafer W reaches 1500 rpm, the first chemical agent valve 58 is opened to supply the first chemical agent from the first chemical agent nozzle 50 toward the rotation center of the front surface of the wafer W. The first chemical agent supplied to the surface of the wafer W flows toward a peripheral edge of the wafer W by a centrifugal force generated by the rotation of the wafer W. Thus, a first chemical agent treatment process is performed to treat the surface of the wafer W with the first chemical agent (Step S2). The first chemical agent flowing toward the peripheral edge of the wafer W is scattered radially outward from the peripheral edge of the wafer W, and flies into the second opening 94 which is opposed to the peripheral surface of the wafer W. Then, the first chemical agent flying into the second opening 94 flows down on the outer surface of the shade member 72 or the inner surface of the shade member 73 to be collected in the first recovery channel 34, and flows into the first recovery/drain passage 38. At this time, the first chemical agent flowing through the first recovery/drain passage 38 is introduced into the first branch recovery passage 39 through the first selector valve 41. Therefore, the first chemical agent is recovered in the first chemical agent tank 59 of the first chemical agent supply source 56 through the first branch recovery passage 39.

After a lapse of a predetermined treatment period from the start of the supply of the first chemical agent to the wafer W, the first chemical agent valve 58 is closed to stop the supply of the first chemical agent from the first chemical agent nozzle 50. Further, the first arm driving mechanism 55 is controlled to pivot the first arm 53 to retract the first chemical agent nozzle 50 and the second chemical agent nozzle 51 from above the wafer W to the retracted position on the lateral side of the spin chuck 20. Then, the second arm driving mechanism 68 is controlled to pivot the second arm 66 to move the pure water nozzle 52 from a retracted position on a lateral side of the spin chuck 20 to above the wafer W. Further, the guard lift driving mechanism 75 is driven to move the splash guard 32 up to a fourth opening opposed position (see FIG. 5(c)) at which the fourth opening 98 is opposed to the peripheral surface of the wafer W.

When the splash guard 32 reaches the fourth opening opposed position, the pure water valve 70 is opened to supply the deionized water from the pure water nozzle 52 toward the rotation center of the surface of the rotating wafer W. The deionized water supplied to the surface of the wafer W flows toward the peripheral edge of the wafer W by the centrifugal force generated by the rotation of the wafer W. Thus, a rinsing process is performed to rinse away the first chemical agent adhering onto the surface of the wafer W with the deionized water (Step S3). The deionized water flowing toward the peripheral edge of the wafer W is scattered radially outward from the peripheral edge of the wafer W. The deionized water (containing the first chemical agent rinsed away from the wafer W) scattered from the peripheral edge of the wafer W is received in the fourth opening 98 opposed to the peripheral surface of the wafer W, and flows down on the inner surface of the shade member 71 to be collected in the drain channel 36 and introduced into the waste water treatment facility not shown from the drain channel 36 through the drain passage 46.

After a lapse of a predetermined treatment period from the start of the supply of the deionized water, the pure water valve 70 is closed to stop the supply of the deionized water to the wafer W. Thereafter, the second arm driving mechanism 68 is controlled to pivot the second arm 66 to retract the pure water nozzle 52 from above the wafer W to the retracted position on the lateral side of the spin chuck 20. Further, the first arm driving mechanism 55 is controlled to pivot the first arm 53 to move the first chemical agent nozzle 50 and the second chemical agent nozzle 51 from the retracted position on the lateral side of the spin chuck 20 to above the wafer W. Further, the guard lift driving mechanism 75 is driven to move the splash guard 32 down to a third opening opposed position (see FIG. 5(d)) at which the third opening 96 is opposed to the peripheral surface of the wafer W.

When the splash guard 32 reaches the third opening opposed position, the second chemical agent valve 63 is opened to supply the second chemical agent from the second chemical agent nozzle 51 toward the rotation center of the surface of the rotating wafer W. The second chemical agent supplied to the surface of the wafer W flows toward the peripheral edge of the wafer W by the centrifugal force generated by the rotation of the wafer W. Thus, a second chemical agent treatment process is performed to treat the surface of the wafer W with the second chemical agent (Step S4). The second chemical agent flowing toward the peripheral edge of the wafer W is scattered radially outward from the peripheral edge of the wafer W, and flies into the third opening 96 which is opposed to the peripheral surface of the wafer W. Then, the second chemical agent flying into the third opening 96 flows down on the inner surface of the shade member 72 or the outer surface of the shade member 71 to be collected in the second recovery channel 35, and flows into the second recovery/drain passage 42. At this time, the second chemical agent flowing through the second recovery/drain passage 42 is introduced into the second branch recovery passage 43 through the second selector valve 45. Therefore, the second chemical agent is recovered in the second chemical agent tank 64 of the second chemical agent supply source 61 through the second branch recovery passage 43.

After a lapse of a predetermined treatment period from the start of the supply of the second chemical agent to the wafer W, the second chemical agent valve 63 is closed to stop the supply of the second chemical agent from the second chemical agent nozzle 51. Further, the first arm driving mechanism 55 is controlled to pivot the first arm 53 to retract the first chemical agent nozzle 50 and the second chemical agent nozzle 51 from above the wafer W to the retracted position on the lateral side of the spin chuck 20. Then, the second arm driving mechanism 68 is controlled to pivot the second arm 66 to move the pure water nozzle 52 from the retracted position on the lateral side of the spin chuck 20 to above the wafer W. Further, the guard lift driving mechanism 75 is driven to move the splash guard 32 down to a first opening opposed position (see FIG. 5(e)) at which the first opening 92 is opposed to the peripheral surface of the wafer W. Then, the pure water valve 70 is opened to supply the deionized water from the pure water nozzle 52 toward the rotation center of the surface of the rotating wafer W (Step S5). Thus, a rinsing process is performed to rinse away the second chemical agent adhering onto the surface of the wafer W with the deionized water. The deionized water (containing the second chemical agent rinsed away from the wafer W) scattered from the peripheral edge of the wafer W in the rinsing process is received in the first opening 92 opposed to the peripheral surface of the wafer W to be collected in the air/liquid expelling channel 33, and introduced into the waste water treatment facility not shown from the air/liquid expelling channel 33 through the air/liquid expelling passage 37.

After a lapse of a predetermined rinsing period from the start of the supply of the deionized water, the pure water valve 70 is closed to stop the supply of the deionized water to the wafer W. Thereafter, the second arm driving mechanism 68 is controlled to pivot the second arm 66 to retract the pure water nozzle 52 from above the wafer W to the retracted position on the lateral side of the spin chuck 20. Further, the guard lift driving mechanism 75 is driven to move down the splash guard 32 from the first opening opposed position to the retracted position. Then, the rotation speed of the wafer W is increased from 1500 rpm to 3000 rpm, and a drying process is performed to spin off the deionized water from the surface of the rinsed wafer W by a centrifugal force to dry the surface of the wafer W (Step S6). In the drying process, the splash guard 32 is located at the retracted position, so that the deionized water scattered from the peripheral edge of the wafer W adheres onto an outer surface of the shade member 74. After the drying process (spin drying process) is performed for a predetermined drying period, the rotation of the wafer W is stopped, and then the treated wafer W is unloaded by the transport robot 16 (Step S7).

After a single lot of wafers W are treated with the first chemical agent and the second chemical agent (YES in Step S8), a recovery cup cleaning process is performed to clean the interior walls of the first to fourth spaces 91, 93, 95, 97 of the recovery cup 30 (Step S9).

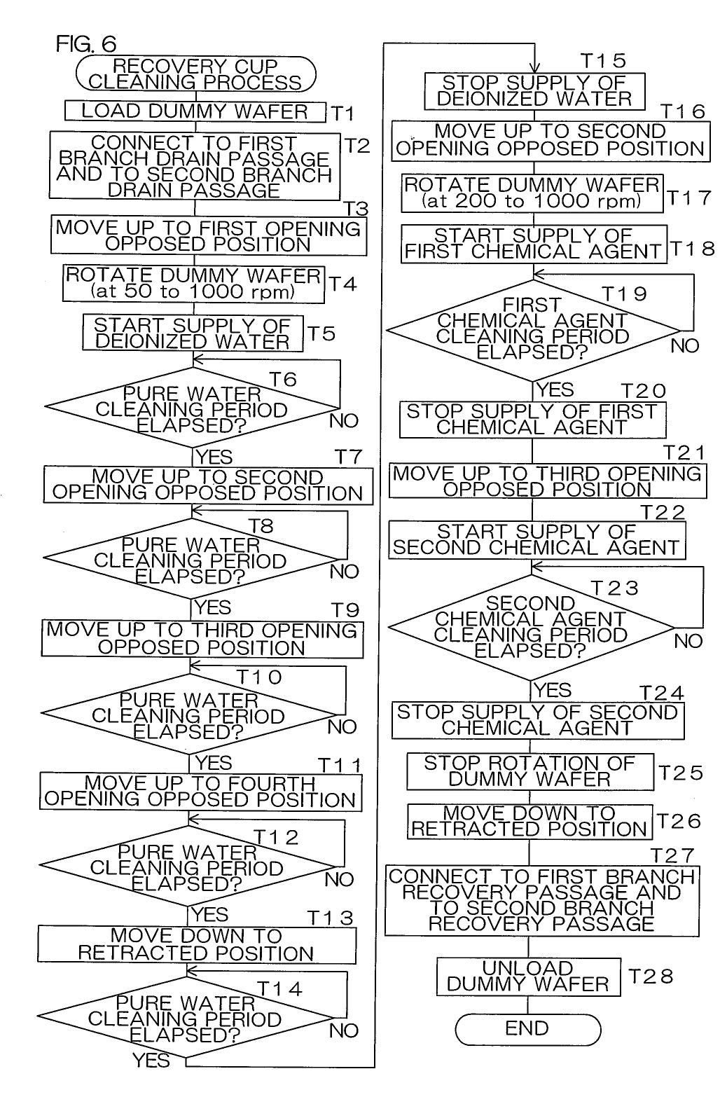

FIG. 6 is a flow chart for explaining a process sequence of the recovery cup cleaning process. The recovery cup cleaning process is performed by causing the spin chuck 20 to hold a dummy wafer DW such as of SiC and supplying the deionized water as a cleaning liquid and the first chemical agent or the second chemical agent as a chemical cleaning agent to the rotating dummy wafer DW. The dummy wafer DW has the same shape and the size as the wafer W to be treated. Therefore, the deionized water, the first chemical agent and the second chemical agent are scattered toward the same position from a peripheral edge of the dummy wafer DW in the recovery cup cleaning process and from the peripheral edge of the wafer W in the wafer treatment process. When the splash guard 32 is located at the first, second, third or fourth opening opposed position (see FIGS. 5(b) to 5(e)), the deionized water, the first chemical agent or the second chemical agent scattered from the peripheral edge of the dummy wafer DW flies into the corresponding opening 92, 94, 96 or 98 to be introduced into the corresponding space 91, 93, 95 or 97.

The transport robot 16 takes the dummy wafer DW from the cassette C2 on the dummy wafer holding base 15. Then, the transport robot 16 loads the dummy wafer DW into the treatment unit 7 and causes the spin chuck 20 to hold the dummy wafer DW (Step T1). With the dummy wafer DW being held by the spin chuck 20, the chuck rotative driving mechanism 24 is controlled to cause the spin chuck 20 to start rotating the dummy wafer DW and increase the rotation speed of the dummy wafer DW to 500 rpm, for example. The first selector valve 41 and the second selector valve 45 are controlled to be switched so that a liquid flowing through the first recovery/drain passage 38 is introduced into the first branch drain passage 40 and a liquid flowing through the second recovery/drain passage 42 is introduced into the second branch drain passage 44 (Step T2). Further, the guard lift driving mechanism 75 is controlled to move up the splash guard 32 from the retracted position to the first opening opposed position (see FIG. 5(e)) at which the first opening 92 is opposed to the peripheral surface of the dummy wafer DW (Step T3). Moreover, the second arm driving mechanism 68 is controlled to pivot the second arm 66 to move the pure water nozzle 52 from the retracted position on the lateral side of the spin chuck 20 to above the dummy wafer DW.

When the rotation speed of the dummy wafer DW reaches 500 rpm, the pure water valve 70 is opened to supply the deionized water from the pure water nozzle 52 toward the rotation center of a surface of the dummy wafer DW (Step T5).

The deionized water supplied to the surface of the dummy wafer DW flows toward the peripheral edge of the dummy wafer DW, and is scattered radially outward from the peripheral edge of the dummy wafer DW to fly into the first opening 92 opposed to the peripheral surface of the dummy wafer DW by a centrifugal force generated by the rotation of the dummy wafer DW. The deionized water flying into the first opening 92 flows down on the inner surface of the shade member 74 and the outer surface of the shade member 73 to be collected in the air/liquid expelling channel 33, and flows into the air/liquid expelling passage 37 from the air/liquid expelling channel 33. Thus, the inner surface of the shade member 74, the outer surface of the shade member 73 and the air/liquid expelling channel 33, i.e., interior walls of the first space 91, are cleaned with the deionized water. The deionized water flowing from the air/liquid expelling passage 37 is introduced into the waste water treatment facility not shown.

On the other hand, the rotation speed of the dummy wafer DW is changed within a range of 50 to 1000 rpm (Step T4), so that the rotation of the dummy wafer DW is cyclically accelerated or decelerated. Therefore, a liquid scattering direction in which the deionized water is scattered from the peripheral edge of the dummy wafer DW is changed, so that a liquid reaching position which the deionized water reaches in the first space 91 is changed. Thus, the deionized water is distributed over a wider range in the first space 91. The rotation speed of the dummy wafer DW is kept changed within the aforesaid range until a cleaning process employing the deionized water ends (Step T15).

After a lapse of a predetermined pure water cleaning period (e.g., 5 to 60 seconds) (YES in Step T6), the guard lift driving mechanism 75 is controlled to move the splash guard 32 up to the second opening opposed position (FIG. 5(b)) at which the second opening 94 is opposed to the peripheral surface of the dummy wafer DW (Step T7). The deionized water scattered radially outward from the peripheral edge of the rotating dummy wafer DW flies into the second opening 94 opposed to the peripheral surface of the dummy wafer DW. The deionized water flying into the second opening 94 flows down on the inner surface of the shade member 73 and the outer surface of the shade member 72 to be collected in the first recovery channel 34, and flows into the first recovery/drain passage 38 from the first recovery channel 34. Thus, the inner surface of the shade member 73, the outer surface of the shade member 72 and the first recovery channel 34, i.e., interior walls of the second space 93, are cleaned with the deionized water. Since the first selector valve 41 is switched in Step T2 so as to introduce the liquid flowing through the first recovery/drain passage 38 into the first branch drain passage 40, the deionized water flowing through the first recovery/drain passage 38 is introduced into the waste water treatment facility not shown through the first branch drain passage 40.

After a lapse of a predetermined pure water cleaning period (e.g., 5 to 60 seconds) (YES in Step T8), the guard lift driving mechanism 75 is controlled to move the splash guard 32 up to the third opening opposed position (FIG. 5(d)) at which the third opening 96 is opposed to the peripheral surface of the dummy wafer DW (Step T9). The deionized water scattered radially outward from the peripheral edge of the rotating dummy wafer DW flies into the third opening 96 opposed to the peripheral surface of the dummy wafer DW. The deionized water flying into the third opening 96 flows down on the inner surface of the shade member 72 and the outer surface of the shade member 71 to be collected in the second recovery channel 35, and flows into the second recovery/drain passage 42. Thus, the inner surface of the shade member 72, the outer surface of the shade member 71 and the second recovery channel 35, i.e., interior walls of the third space 95, are cleaned with the deionized water. Since the second selector valve 45 is switched in Step T2 so as to introduce the liquid flowing through the second recovery/drain passage 42 into the second branch drain passage 44, the deionized water flowing through the second recovery/drain passage 42 is introduced into the waste water treatment facility not shown through the second branch drain passage 44.

After a lapse of a predetermined pure water cleaning period (e.g., 5 to 60 seconds) (YES in Step T10), the guard lift driving mechanism 75 is controlled to move the splash guard 32 up to the fourth opening opposed position (FIG. 5(c)) at which the fourth opening 98 is opposed to the peripheral surface of the dummy wafer DW (Step T11). The deionized water scattered radially outward from the peripheral edge of the rotating dummy wafer DW flies into the fourth opening 98 opposed to the peripheral surface of the dummy wafer DW. The deionized water flying into the fourth opening 98 flows down on the inner surface of the shade member 71 to be collected in the drain channel 36, and flows into the drain passage 46 from the drain channel 36. Thus, the inner surface of the shade member 71 and the drain channel 36, i.e., interior walls of the fourth space 97, are cleaned with the deionized water. The deionized water flowing into the drain passage 46 is introduced into the waste water treatment facility not shown.

After a lapse of a predetermined pure water cleaning period (e.g., 5 to 60 seconds) (YES in Step T12), the guard lift driving mechanism 75 is controlled to move the splash guard 32 down to the retracted position (FIG. 5(a)) from the fourth opening opposed position (Step T13). The deionized water scattered radially outward from the peripheral edge of the rotating dummy wafer DW flows down on the outer surface of the shade member 74 opposed to the peripheral surface of the dummy wafer DW, and is introduced into the waste water treatment facility not shown through a drain passage not shown. Thus, the outer surface of the shade member 74 on which the deionized water scattered from the wafer W is likely to adhere in the wafer drying process is cleaned with the deionized water.

After a lapse of a predetermined pure water cleaning period (e.g., 5 to 60 seconds) (YES in Step T14), the pure water valve 70 is closed to stop the supply of the deionized water to the dummy wafer DW (Step T15) Thereafter, the second arm driving mechanism 68 is controlled to pivot the second arm 66 to retract the pure water nozzle 52 from above the dummy wafer DW to the retracted position on the lateral side of the spin chuck 20. At the same time, the first arm driving mechanism 55 is controlled to pivot the first arm 53 to move the first chemical agent nozzle 50 and the second chemical agent nozzle 51 from the retracted position on the lateral side of the spin chuck 20 to above the dummy wafer DW.

Thereafter, the guard lift driving mechanism 75 is driven to move the splash guard 32 up to the second opening opposed position (see FIG. 5(b)) from the retracted position (Step T16). The range of the rotation speed of the dummy wafer DW is changed from the previous range (50 to 1000 rpm) to a range of 200 to 1000 rpm (Step T17). Therefore, a liquid scattering direction in which the first chemical agent or the second chemical agent is scattered from the peripheral edge of the dummy wafer DW is changed, so that the first chemical agent or the second chemical agent is distributed over a wider range in the first space 91. The rotation speed of the dummy wafer DW is kept changed within the aforesaid range (200 to 1000 rpm) until the rotation of the dummy wafer DW is stopped (Step T25).

Thereafter, the first chemical agent valve 58 is opened to supply the first chemical agent from the first chemical agent nozzle 50 toward the rotation center of the surface of the dummy wafer DW (Step T18). The first chemical agent supplied to the surface of the dummy wafer DW flows toward the peripheral edge of the dummy wafer DW to be scattered radially outward from the peripheral edge of the dummy wafer DW by a centrifugal force generated by the rotation of the dummy wafer DW, and flies into the second opening 94 opposed to the peripheral surface of the dummy wafer DW. The first chemical agent flying into the second opening 94 flows down on the inner surface of the shade member 73 and the outer surface of the shade member 72 to be collected in the first recovery channel 34, and flows into the first recovery/drain passage 38 from the first recovery channel 34. Thus, the inner surface of the shade member 73, the outer surface of the shade member 72 and the first recovery channel 34, i.e., the interior walls of the second space 93, are cleaned with the first chemical agent. Since the first selector valve 41 is switched in Step T2 so as to introduce the liquid flowing through the first recovery/drain passage 38 into the first branch drain passage 40, the first chemical agent flowing through the first recovery/drain passage 38 is introduced into the waste water treatment facility not shown through the first branch drain passage 40.

After a lapse of a predetermined first chemical agent cleaning period (e.g., 5 to 60 seconds) (YES in Step T19), the first chemical agent valve 58 is closed to stop the supply of the first chemical agent to the dummy wafer DW (Step T20). Thereafter, the guard lift driving mechanism 75 is driven to move the splash guard 32 up to the third opening opposed position (see FIG. 5(d)) from the second opening opposed position (Step T21).

When the splash guard 32 reaches the third opening opposed position, the second chemical agent valve 63 is opened to supply the second chemical agent from the second chemical agent nozzle 51 toward the rotation center of the surface of the dummy wafer DW (Step T22). The second chemical agent supplied to the surface of the dummy wafer DW flows toward the peripheral edge of the dummy wafer DW to be scattered radially outward from the peripheral edge of the dummy wafer DW by the centrifugal force generated by the rotation of the dummy wafer DW, and flies into the third opening 96 opposed to the peripheral surface of the dummy wafer DW. The second chemical agent flying into the third opening 96 flows down on the inner surface of the shade member 72 and the outer surface of the shade member 71 to be collected in the second recovery channel 35, and flows into the second recovery/drain passage 42. Thus, the inner surface of the shade member 72, the outer surface of the shade member 71 and the second recovery channel 35, i.e., the interior walls of the third space 95, are cleaned with the second chemical agent. Since the second selector valve 45 is switched in Step T2 so as to introduce the liquid flowing through the second recovery/drain passage 42 into the second branch drain passage 44, the second chemical agent flowing through the second recovery/drain passage 42 is introduced into the waste water treatment facility not shown through the second branch drain passage 44.

After a lapse of a predetermined second chemical agent cleaning period (e.g., 5 to 60 seconds) (YES in Step T23), the second chemical agent valve 63 is closed to stop the supply of the second chemical agent to the dummy wafer DW (Step T24). Further, the rotation of the dummy wafer DW is stopped (Step T25).

Thereafter, the guard lift driving mechanism 75 is driven to move the splash guard 32 down to the retracted position (Step T26). Further, the first selector valve 41 and the second selector valve 45 are controlled to be switched so that the liquid flowing through the first recovery/drain passage 38 is introduced into the first branch recovery passage 39 and the liquid flowing through the second recovery/drain passage 42 is introduced into the second branch recovery passage 43 (Step T27).

Then, the used dummy wafer DW is transported out of the treatment unit 7 by the transport robot 16, and accommodated in the cassette C2 on the dummy wafer holding base 15 (Step T28).

According to this embodiment, as described above, the interior walls of the first to fourth spaces 91, 93, 95, 97 and the outer surface of the shade member 74 are cleaned with the deionized water, the first chemical agent or the second chemical agent. Thus, substances and crystals of the substances adhering on the interior walls of the spaces 91, 93, 95, 97 and the outer surface of the shade member 74 are removed. This suppresses generation of particles.

Further, the deionized water used for the cleaning of the interior walls of the second space 93 and the third space 95 is drained from the second space 93 and the third space 95 through the first branch drain passage 40 and the second branch drain passage 44, respectively. Therefore, the deionized water is unlikely to enter the first branch recovery passage 39 and the second branch recovery passage 43. Even if the interior walls of the second space 93 and the third space 95 are cleaned with the deionized water, the first chemical agent to be supplied to the wafer W from the first chemical agent nozzle 50 and the second chemical agent to be supplied to the wafer W from the second chemical agent nozzle 51 are unlikely to be contaminated with the deionized water used for the cleaning of the recovery cup.

Further, the interior walls of the second space 93 and the third space 95 are cleaned with the first chemical agent and the second chemical agent, respectively, after having been cleaned with the deionized water. Therefore, the deionized water adhering onto the interior walls of the second space 93 and the interior walls of the third space 95 cleaned with the deionized water is rinsed away with the first chemical agent and the second chemical agent, respectively. This more reliably suppresses or prevents the contamination of the first chemical agent to be supplied to the wafer W from the first chemical agent nozzle 50 and the second chemical agent to be supplied to the wafer W from the second chemical agent nozzle 51 with the deionized water used for the cleaning of the recovery cup.

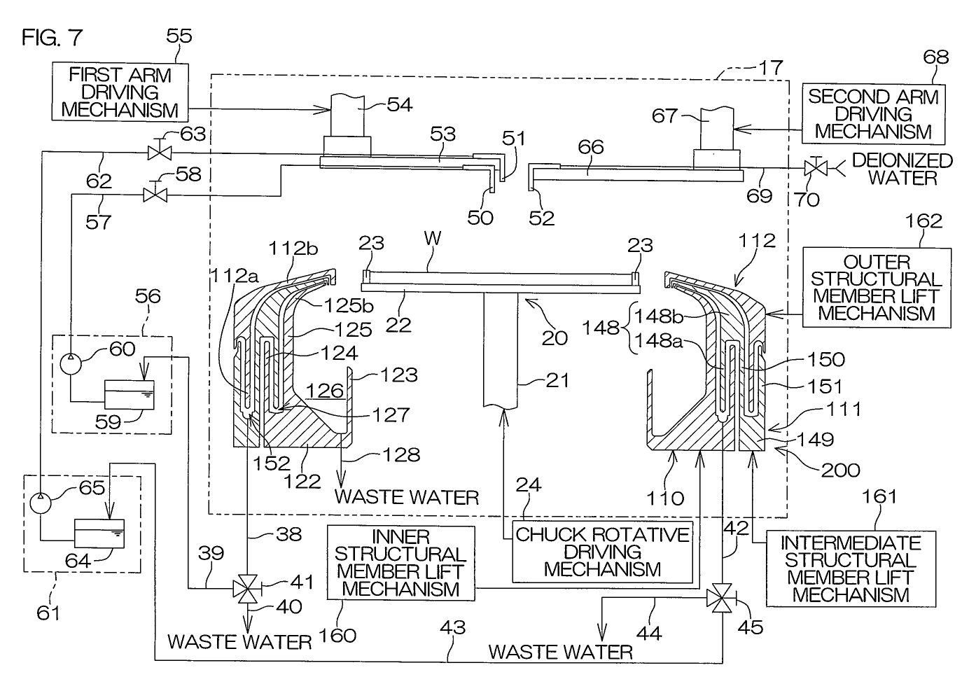

FIG. 7 is a sectional view schematically showing the construction of a treatment unit of a substrate treatment apparatus according to another embodiment (second embodiment) of the present invention. In FIG. 7, components corresponding to those shown in FIG. 2 will be denoted by the same reference characters as in FIG. 2, and will not be explained. This substrate treatment apparatus is different from the embodiment (first embodiment) shown in FIG. 2 in that a recovery cup 200 thereof includes, instead of the cup 31 and the splash guard 32, an inner structural member 110, an intermediate structural member 111 and an outer structural member 112 which are independently movable up and down.

The inner structural member 110 surrounds the spin chuck 20, and has a shape generally rotationally symmetric about the rotation axis of the wafer W to be rotated by the spin chuck 20. The inner structural member 110 integrally includes an annular bottom portion 122 as seen in plan, a cylindrical inner wall 123 projecting upward from an inner peripheral edge of the bottom portion 122, a cylindrical outer wall 124 projecting upward from an outer peripheral edge of the bottom portion 122, and a first guide portion 125 projecting upward from a portion thereof between the inner wall 123 and the outer wall 124 and having an upper edge portion 125b extending obliquely upward toward the center axis thereof (toward the rotation axis of the wafer W). A drain channel 126 in which a treatment liquid (deionized water containing the first chemical agent and the second chemical agent) used for the treatment of the wafer W is collected to be drained is defined between the inner wall 123 and the first guide portion 125. Further, an inner recovery channel 127 in which a treatment liquid used for the treatment of the wafer W is collected to be recovered is defined between the first guide portion 125 and the outer wall 124. The drain channel 126 is connected to a drain passage 128 through which the treatment liquid is introduced into the waste water treatment facility not shown. The inner recovery channel 127 is adapted to recover the second chemical agent, and the second recovery/drain passage 42 is connected to the inner recovery channel 127.

The intermediate structural member 111 surrounds the spin chuck 20, and has a shape generally rotationally symmetric about the rotation axis of the wafer W to be rotated by the spin chuck 20. The intermediate structural member 111 integrally includes a second guide portion 148, an annular bottom portion 149 as seen in plan, an annular inner wall 150 projecting upward from an inner peripheral edge of the bottom portion 149 and connected to the second guide portion 148, and a cylindrical outer wall 151 projecting upward from an outer peripheral edge of the bottom portion 149.

The second guide portion 148 includes a cylindrical lower edge portion 148a disposed outward of the first guide portion 125 of the inner structural member 110 coaxially with a lower portion of the first guide portion 125, and an upper edge portion 148b smoothly arcuately extending obliquely upward from an upper edge of the lower edge portion 148a toward the center axis thereof (toward the rotation axis of the wafer W). The lower edge portion 148a is located above the inner recovery channel 127. The upper edge portion 148b vertically overlaps with the upper edge portion 125b of the first guide portion 125 of the inner structural member 110.

The upper edge portion 148b of the second guide portion 148 has a wall thickness which is progressively increased toward the lower side. The inner wall 150 is connected to an outer peripheral edge of the upper edge portion 148b. The bottom portion 149, the inner wall 150 and the outer wall 151 form a generally U-shaped portion as seen in section, and an outer recovery channel 152 in which the first chemical agent used for the treatment of the wafer W is collected to be recovered is defined by the bottom portion 149, the inner wall 150 and the outer wall 151. The first recovery/drain passage 38 is connected to the outer recovery channel 152.

The outer structural member 112 is disposed outward of the second guide portion 148 of the intermediate structural member 111 as surrounding the spin chuck 20, and has a shape generally rotationally symmetric about the rotation axis of the wafer W to be rotated by the spin chuck 20. The outer structural member 112 includes a cylindrical lower edge portion 112a coaxial with the lower edge portion 148a of the second guide portion 148, and an upper edge portion 112b smoothly arcuately extending obliquely upward from an upper edge of the lower edge portion 112a toward the center axis thereof (toward the rotation axis of the wafer W). The upper edge portion 112b vertically overlaps with the upper edge portion 148b of the second guide portion 148 of the intermediate structural member 111.

The recovery cup 200 further includes an inner structural member lift mechanism 160 for moving up and down the inner structural member 110, an intermediate structural member lift mechanism 161 for moving up and down the intermediate structural member 111, and an outer structural member lift mechanism 162 for moving up and down the outer structural member 112.

The local control section 101 (see FIG. 3) is connected to the inner structural member lift mechanism 160, the intermediate structural member lift mechanism 161 and the outer structural member lift mechanism 162 as control objects. The local control section 101 controls the operations of the inner structural member lift mechanism 160, the intermediate structural member lift mechanism 161 and the outer structural member lift mechanism 162.

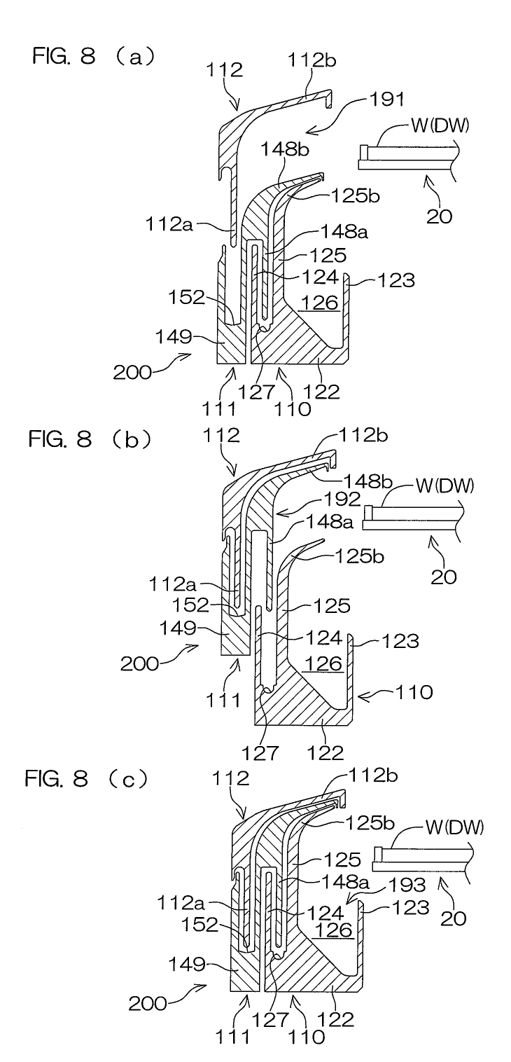

FIGS. 8(a) to 8(c) are partial sectional views schematically showing positional relationships between the spin chuck 20 and the recovery cup 200 during the treatment of the wafer W to be performed by the substrate treatment apparatus according to the second embodiment.

When the upper edge portion 112b of the outer structural member 112 is located at a higher level than the wafer W held by the spin chuck 20 and the upper edge portion 125b of the first guide portion 125 of the inner structural member 110 and the upper edge portion 148b of the second guide portion 148 of the intermediate structural member 111 are located at lower levels than the wafer W (see FIG. 8(a)), an opening is defined between the upper edge portion 148b of the second guide portion 148 and the upper edge portion 112b of the outer structural member 112 as being opposed to the peripheral surface of the wafer W. With the structural members 110 to 112 of the recovery cup 200 located in such a positional relationship, the wafer W is treated with the first chemical agent.

The first chemical agent scattered radially outward from the peripheral edge of the wafer W flies into a space defined between the second guide portion 148 and the outer structural member 112. The first chemical agent flying into the space flows down on an outer surface of the second guide portion 148 or an inner surface of the outer structural member 112, and is collected in the outer recovery channel 152 and introduced into the first branch recovery passage 39 through the first recovery/drain passage 38 to be recovered in the first chemical agent supply source 56. In other words, a fifth space 191 into which the first chemical agent used for the treatment of the wafer W is introduced is defined by the inner surface of the outer structural member 112, the outer surface of the second guide portion 148 and the outer recovery channel 152.

When the upper edge portion 112b of the outer structural member 112 and the upper edge portion 148b of the second guide portion 148 of the intermediate structural member 111 are located at higher levels than the wafer W and the upper edge portion 125b of the first guide portion 125 of the inner structural member 110 is located at a lower level than the wafer W (see FIG. 8(b)), an opening is defined between the upper edge portion 125b of the first guide portion 125 and the upper edge portion 148b of the second guide portion 148 as being opposed to the peripheral surface of the wafer W. With the structural members 110 to 112 of the recovery cup 200 located in such a positional relationship, the wafer W is treated with the second chemical agent.

The second chemical agent scattered radially outward from the peripheral edge of the wafer W flies into a space defined between the first guide portion 125 and the second guide portion 148. The second chemical agent flying into the space flows down on an inner surface of the second guide portion 148 or an outer surface of the first guide portion 125, and is collected in the inner recovery channel 127 and introduced into the second branch recovery passage 43 from the inner recovery channel 127 through the second recovery/drain passage 42 to be recovered in the second chemical agent supply source 61. In other words, a sixth space 192 into which the second chemical agent used for the treatment of the wafer W is introduced is defined by the inner surface of the intermediate structural member 111, the outer surface of the inner structural member 110 and the inner recovery channel 127.

When the upper edge portion 112b of the outer structural member 112, the upper edge portion 148b of the second guide portion 148 and the upper edge portion 125b of the first guide portion 125 are located at higher levels than the wafer W (see FIG. 8(c)), an opening is defined between the upper edge portion 125b and the inner wall 123 as being opposed to the peripheral surface of the wafer W. With the structural members 110 to 112 located in such a positional relationship with respect to the spin chuck 20, a rinsing process is performed on the wafer W.

In the rinsing process, the deionized water (containing the first chemical agent and the second chemical agent) scattered radially outward from the peripheral edge of the wafer W flies into a space defined between the inner wall 123 and the first guide portion 125. Then, the deionized water flows down on an inner surface of the first guide portion 125 to be collected in the drain channel 126 and introduced into the waste water treatment facility not shown from the drain channel 126 through the drain passage 128. In other words, a seventh space 193 into which the treatment liquid used for the treatment of the wafer W is defined by the inner surface of the first guide portion 125 and the drain channel 126.

When the wafer W is to be loaded or unloaded and when the drying process is to be performed, the recovery cup 200 is in a retracted state (see FIG. 7) such that the upper edge portion 125b of the first guide portion 125 of the inner structural member 110, the upper edge portion 148b of the second guide portion 148 of the intermediate structural member 111 and the upper edge portion 112b of the outer structural member 112 are located at lower levels than the wafer W held by the spin chuck 20.

In a cup cleaning process for cleaning the recovery cup 200, as in Steps T1 to T14 in FIG. 6, a dummy wafer DW is loaded into the treatment unit 7 by the transport robot 16 and held by the spin chuck 20, and the chuck rotative driving mechanism 24 is controlled so that the spin chuck 20 starts rotating the dummy wafer DW and increases the rotation speed of the dummy wafer DW up to 500 rpm, for example. Further, the first selector valve 41 and the second selector valve 45 are controlled to be switched so that the liquid flowing through the first recovery/drain passage 38 is introduced into the first branch drain passage 40 and the liquid flowing through the second recovery/drain passage 42 is introduced into the second branch drain passage 44. The fifth space 191, the sixth space 192, the seventh space 193 and an outer surface of the outer structural member 112 of the recovery cup 200 are cleaned in this order with the deionized water. The outer structural member lift mechanism 162 is controlled to move up the outer structural member 112, whereby the peripheral surface of the dummy wafer DW is opposed to the opening defined between the upper edge portion 112b of the outer structural member 112 and the upper edge portion 148b of the second guide portion 148 as shown in FIG. 8(a).

When the rotation speed of the dummy wafer DW reaches 500 rpm, the deionized water is supplied from the pure water nozzle 52 toward the rotation center of the surface of the dummy wafer DW. The deionized water supplied to the surface of the dummy wafer DW flows toward the peripheral edge of the dummy wafer DW to be scattered radially outward from the peripheral edge of the dummy wafer DW by a centrifugal force generated by the rotation of the dummy wafer DW. The deionized water scattered radially outward from the peripheral edge of the dummy wafer DW flies into the space defined between the intermediate structural member 111 and the outer structural member 112. The deionized water flying into the space flows down on the outer surface of the intermediate structural member 111 and the inner surface of the outer structural member 112 to be collected in the outer recovery channel 152, and flows into the first recovery/drain passage 38 from the outer recovery channel 152. Thus, the inner surface of the outer structural member 112, the outer surface of the intermediate structural member 111 and the outer recovery channel 152, i.e., interior walls of the fifth space 191, are cleaned with the deionized water. Since the first selector valve 41 is switched so as to introduce the liquid flowing through the first recovery/drain passage 38 into the first branch drain passage 40, the deionized water flowing through the first recovery/drain passage 38 is introduced into the waste water treatment facility not shown through the first branch drain passage 40.

After a lapse of a predetermined pure water cleaning period (e.g., 5 to 60 seconds), the intermediate structural member lift mechanism 161 is controlled to move up the intermediate structural member 111, whereby the peripheral surface of the dummy wafer DW is opposed to the opening defined between the upper edge portion 148b of the second guide portion 148 and the upper edge portion 125b of the first guide portion 125 as shown in FIG. 8(b). The deionized water scattered radially outward from the peripheral edge of the rotating dummy wafer DW flies into the space defined between the first guide portion 125 of the inner structural member 110 and the second guide portion 148 of the intermediate structural member 111. The deionized water flying into the space defined between the first guide portion 125 and the second guide portion 148 flows down on the inner surface of the second guide portion 148 and the outer surface of first guide portion 125 to be collected in the inner recovery channel 127, and flows into the second recovery/drain passage 42 from the inner recovery channel 127. Thus, the inner surface of the second guide portion 148, the outer surface of the first guide portion 125 and the inner recovery channel 127, i.e., interior walls of the sixth space 192, are cleaned with the deionized water. Since the second selector valve 45 is switched so as to introduce the liquid flowing through the second recovery/drain passage 42 into the second branch drain passage 44, the deionized water flowing through the second recovery/drain passage 42 is introduced into the waste water treatment facility not shown through the second branch drain passage 44.

After a lapse of a predetermined pure water cleaning period (e.g., 5 to 60 seconds), the inner structural member lift mechanism 160 is controlled to move up the inner structural member 110, whereby the peripheral surface of the dummy wafer DW is opposed to the opening defined between the upper edge portion 125b of the first guide portion 125 and the upper edge of the inner wall 123 as shown in FIG. 8(c). The deionized water scattered radially outward from the peripheral edge of the rotating dummy wafer DW flies into the space defined between the inner wall 123 and the first guide portion 125. The deionized water flying into the space defined between the inner wall 123 and the first guide portion 125 flows down on the inner surface of the first guide portion 125 to be collected in the drain channel 126, and flows into the drain passage 128 from the drain channel 126. Thus, the inner surface of the first guide portion 125 and the drain channel 126, i.e., interior walls of the seventh space 193, are cleaned with the deionized water. The deionized water flowing into the drain passage 128 is introduced into the waste water treatment facility not shown.

After a lapse of a predetermined pure water cleaning period (e.g., 5 to 60 seconds), the supply of the deionized water to the dummy wafer DW is stopped as in Step T15.

Thereafter, the inner structural member lift mechanism 160 and the intermediate structural member lift mechanism 161 are controlled to move down the inner structural member 110 and the intermediate structural member 111, whereby the peripheral surface of the dummy wafer DW is opposed to the opening defined between the upper edge portion 112b of the outer structural member 112 and the upper edge portion 148b of the second guide portion 148.

In this state, the first chemical agent is supplied from the first chemical agent nozzle 50 toward the rotation center of the dummy wafer DW. The first chemical agent supplied to the surface of the dummy wafer DW flows toward the peripheral edge of the dummy wafer DW to be scattered radially outward from the peripheral edge of the dummy wafer DW by the centrifugal force generated by the rotation of the dummy wafer DW. The first chemical agent scattered radially outward from the peripheral edge of the dummy wafer DW flies into the space defined between the intermediate structural member 111 and the outer structural member 112. The first chemical agent flying into the space flows down on the outer surface of the intermediate structural member 111 and the inner surface of the outer structural member 112 to be collected in the outer recovery channel 152, and flows into the first recovery/drain passage 38 from the outer recovery channel 152. Thus, the inner surface of the outer structural member 112, the outer surface of the intermediate structural member 111 and the outer recovery channel 152 are cleaned with the first chemical agent. Since the first selector valve 41 is switched so as to introduce the liquid flowing through the first recovery/drain passage 38 into the first branch drain passage 40, the first chemical agent flowing through the first recovery/drain passage 38 is introduced into the waste water treatment facility not shown through the first branch drain passage 40.

After a lapse of a predetermined first chemical agent cleaning period (e.g., 5 to 60 seconds), the supply of the first chemical agent to the dummy wafer DW is stopped as in Step T20.

Thereafter, the intermediate structural member lift mechanism 161 is controlled to move up the intermediate structural member 111, whereby the peripheral surface of the dummy wafer DW is opposed to the opening defined between the upper edge portion 148b of the second guide portion 148 and the upper edge portion 125b of the first guide portion 125 as shown in FIG. 8(b).

In this state, the second chemical agent is supplied from the second chemical agent nozzle 51 toward the rotation center of the dummy wafer DW. The second chemical agent scattered radially outward from the peripheral edge of the rotating dummy wafer DW flies into the space defined between the first guide portion 125 of the inner structural member 110 and the second guide portion 148 of the intermediate structural member 111. The second chemical agent flying into the space defined between the first guide portion 125 and the second guide portion 148 flows down on the inner surface of the second guide portion 148 and the outer surface of the first guide portion 125 to be collected in the inner recovery channel 127, and flows into the second recovery/drain passage 42 from the inner recovery channel 127. Thus, the inner surface of the second guide portion 148, the outer surface of the first guide portion 125 and the inner recovery channel 127 are cleaned with the second chemical agent. Since the second selector valve 45 is switched so as to introduce the liquid flowing through the second recovery/drain passage 42 into the second branch drain passage 44, the second chemical agent flowing through the second recovery/drain passage 42 is introduced into the waste water treatment facility not shown through the second branch drain passage 44.

After a lapse of a predetermined second chemical agent cleaning period (e.g., 5 to 60 seconds), the supply of the second chemical agent to the dummy wafer DW is stopped as in Step T24.

Thereafter, the intermediate structural member lift mechanism 161 and the outer structural member lift mechanism 162 are driven to move down the intermediate structural member 111 and the outer structural member 112, whereby the upper edge portion 125b of the first guide portion 125, the upper edge portion 148b of the second guide portion 148 and the upper edge portion 112b of the outer structural member 112 are located at lower levels than the wafer W held by the spin chuck 20 (see FIG. 7). Further, as shown in Step T27, the first selector valve 41 and the second selector valve 45 are controlled to be switched so that the liquid flowing through the first recovery/drain passage 38 is introduced into the first branch recovery passage 39 and the liquid flowing through the second recovery/drain passage 42 is introduced into the second branch recovery passage 43.

Thereafter, the used dummy wafer DW is transported out of the treatment unit 7 by the transport robot 16 and accommodated in the cassette C2 on the dummy wafer holding base 15.

According to the second embodiment, as described above, the inner walls of the fifth to seventh spaces 191, 192, 193 and the outer surface of the outer structural member 112 are cleaned with the deionized water, the first chemical agent or the second chemical agent. Thus, substances and crystals of the substances adhering onto the interior walls of the spaces 191, 192, 193 and the outer surface of the outer structural member 112 are removed. This suppresses generation of particles.

Further, the deionized water used for the cleaning of the interior walls of the fifth space 191 and the sixth space 192 is drained from the fifth space 191 and the sixth space 192 through the first branch drain passage 40 and the second branch drain passage 44, respectively. Therefore, the deionized water used for the cleaning of the recovery cup is unlikely to enter the first branch recovery passage 39 and the second branch recovery passage 43. Even if the interior walls of the fifth space 191 and the sixth space 192 are cleaned with the deionized water, the first chemical agent to be supplied to the wafer W from the first chemical agent nozzle 50 and the second chemical agent to be supplied to the wafer W from the second chemical agent nozzle 51 are unlikely to be contaminated with the deionized water used for the cleaning of the recovery cup.

Further, the interior walls of the fifth space 191 and the sixth space 192 are cleaned with the first chemical agent and the second chemical agent, respectively, after having been cleaned with the deionized water. Therefore, the deionized water adhering onto the interior walls of the fifth space 191 and the interior walls of the sixth space 192 cleaned with the deionized water is rinsed away with the first chemical agent and the second chemical agent, respectively. This more reliably suppresses or prevents the contamination of the first chemical agent to be supplied to the wafer W from the first chemical agent nozzle 50 and the second chemical agent to be supplied to the wafer W from the second chemical agent nozzle 51 with the deionized water used for the cleaning of the recovery cup.

While the two embodiments of the present invention have thus been described, the invention may be embodied in other ways.

The first embodiment (shown in FIG. 2) described above is designed such that the liquid reaching positions of the deionized water, the first chemical agent and the second chemical agent in the recovery cup 30 are changed by changing the rotation speed of the spin chuck 20. Alternatively, the liquid reaching positions of the deionized water, the first chemical agent and the second chemical agent in the recovery cup 30 may be changed by moving up and down the splash guard 32.

The two embodiments described above are each designed such that the chemical agent treatment of the wafer W and the cleaning of the recovery cup 30, 200 share the first and second chemical agent nozzles 50, 51 for supplying the first and second chemical agents. Alternatively, the first and second chemical agents for the chemical agent treatment process and the first and second chemical agents for the recovery cup cleaning process may be supplied from different chemical agent nozzles.

The two embodiments described above each employ the deionized water for the cleaning of the recovery cup 30, 200, but a cleaning liquid other than the deionized water may be employed. In this case, a cleaning liquid nozzle for supplying the cleaning liquid should be provided in addition to the deionized water nozzle 52.

The two embodiments described above are each designed such that the recovery cup 30, 200 is cleaned upon completion of the treatment of every lot of wafers W with the first and second chemical agents, but this is not limitative. For example, the recovery cup cleaning process may be performed before the start of the treatment of every lot of wafers W, or may be performed before and after the treatment of every lot of wafers W. Alternatively, the recovery cup cleaning process may be performed, for example, at a predetermined time everyday.

Although the two embodiments described above are each designed such that the dummy wafer holding base 15 for holding the dummy wafer DW is disposed in the transport chamber 6, the position of the dummy wafer holding base 15 is not limited to this position. The dummy wafer holding base 15 may be disposed above any of the treatment units 7 to 10.

Further, the cleaning of the interior walls of the spaces 91, 93, 95, 97, 191, 192, 193 may be achieved by supplying the deionized water, the first chemical agent or the second chemical agent to the flat spin base 22 of the spin chuck 20, rather than to the dummy wafer DW held by the spin chuck 20, to scatter the deionized water, the first chemical agent or the second chemical agent from the peripheral edge of the spin base 22 into the spaces 91, 93, 95, 97, 191, 192, 193.

The two embodiments described above each employ the multi-stage recovery cup 30, 200 by way of example, but the present invention may be applied to a recovery cup including a single cup.

While the present invention has been described in detail by way of the embodiments thereof, it should be understood that these embodiments are merely illustrative of the technical principles of the present invention but not limitative of the invention. The spirit and scope of the present invention are to be limited only by the appended claims.

This application corresponds to Japanese Patent Application No. 2006-341460 filed in the Japanese Patent Office on Dec. 19, 2006, the disclosure of which is incorporated herein by reference.

What is claimed is:

1. A recovery cup cleaning method for cleaning a recovery cup having an interior wall partitioning a recovery space into which a chemical agent used for treating a substrate is introduced, the recovery cup being configured such that the chemical agent introduced into the recovery space is further introduced into a predetermined chemical agent recovery passage so as to be recovered, the method comprising the steps of:
cleaning the interior wall of the recovery space with a cleaning liquid;
cleaning the interior wall of the recovery space with a chemical cleaning agent after the step of cleaning with the cleaning liquid, the chemical cleaning agent being of the same type as the chemical agent to be recovered through the recovery space; and
draining the cleaning liquid introduced into the recovery space in the step of cleaning with the cleaning liquid and the chemical cleaning agent introduced into the recovery space in the step of cleaning with the chemical cleaning agent through a drain passage which is different from the chemical agent recovery passage.

2. The recovery cup cleaning method according to claim 1,
wherein the recovery space surrounds a substrate rotation unit which holds and rotates the substrate,
the method further comprising the step of operating the substrate rotation unit in the step of cleaning with the cleaning liquid and in the step of cleaning with the chemical cleaning agent,
wherein the step of cleaning with the cleaning liquid includes the step of supplying the cleaning liquid toward the substrate rotation unit,
wherein the step of cleaning with the chemical cleaning agent includes the step of supplying the chemical cleaning agent toward the substrate rotation unit.

3. The recovery cup cleaning method according to claim 2,
wherein the substrate rotation unit operating step is the step of rotating a dummy substrate held by the substrate rotation unit,
wherein the cleaning liquid supplying step includes the step of supplying the cleaning liquid to the dummy substrate being rotated,
wherein the chemical cleaning agent supplying step includes the step of supplying the chemical cleaning agent to the dummy substrate being rotated.

4. The recovery cup cleaning method according to claim 2, wherein the substrate rotation unit operating step includes the step of changing an operation speed of the substrate rotation unit.

5. The recovery cup cleaning method according to claim 2, further comprising the step of moving the substrate rotation unit and the recovery cup relative to each other parallel to a rotation axis of the substrate rotated by the substrate rotation unit in at least one of the step of cleaning with the cleaning liquid and the step of cleaning with the chemical cleaning agent.

6. A substrate treatment apparatus comprising:
a chemical agent supply unit which supplies a chemical agent to a substrate;
a recovery cup having an interior wall partitioning a recovery space into which the chemical agent used for treating the substrate is introduced;
a chemical agent recovery passage through which the chemical agent introduced into the recovery space is recovered;
a drain passage through which a liquid introduced into the recovery space is drained;
a switching unit configured such that the liquid introduced into the recovery space is further introduced selectively into the chemical agent recovery passage and into the drain passage;
a cleaning liquid supply unit which supplies a cleaning liquid for cleaning the interior wall of the recovery space;
a chemical cleaning agent supply unit which supplies a chemical cleaning agent to the interior wall of the recovery space after the cleaning liquid is supplied to the interior wall of the recovery space by the cleaning liquid supply unit, the chemical cleaning agent being of the same type as the chemical agent to be recovered through the recovery space; and
a control unit which controls the switching unit so that the chemical agent introduced into the recovery space is further introduced into the chemical agent recovery passage when the chemical agent is supplied to the substrate by the chemical agent supply unit, and the liquid introduced into the recovery space is further introduced into the drain passage when the cleaning liquid is supplied to the interior wall of the recovery space by the cleaning liquid supply unit and when the chemical cleaning agent is supplied to the interior wall of the recovery space by the chemical cleaning agent supply unit.

7. The substrate treatment apparatus according to claim 6, further comprising a substrate rotation unit which holds and rotates the substrate,
wherein the chemical agent supply unit includes a chemical agent nozzle which supplies the chemical agent toward the substrate rotation unit,
wherein the cleaning liquid supply unit includes a cleaning liquid nozzle which supplies the cleaning liquid toward the substrate rotation unit,
wherein the chemical cleaning agent supply unit includes a chemical cleaning agent nozzle which supplies the chemical cleaning agent toward the substrate rotation unit.

8. The substrate treatment apparatus according to claim 6, wherein the chemical agent supply unit doubles as the chemical cleaning agent supply unit.

9. The substrate treatment apparatus according to claim 7,
wherein the substrate rotation unit and the recovery cup are accommodated in a treatment chamber,
wherein a dummy substrate holder for holding a dummy substrate to be held by the substrate rotation unit is provided outside the treatment chamber.
